(19) United States
(12) Patent Application Publication
(10) Pub. No.: US 2003/0078097 A1
(43) Pub. Date: Apr. 24, 2003

(54) Interactive communication system for communicating video game and karaoke software

(76) Inventor: Takeya Okamoto, Nagoya (JP)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 09/734,469

(22) Filed: Dec. 11, 2000

Related U.S. Application Data
(63) Continuation-in-part of application No. 09/109,784, filed on Jul. 2, 1998, now Pat. No. 6,193,520.
Application No. 09/109,784 is a continuation-in-part of application No. 08/642,560, filed on May 3, 1996, now Pat. No. 5,775,995.
Application No. 08/642,560 is a division of application No. 08/555,400, filed on Nov. 9, 1995, now Pat. No. 5,735,744.
Application No. 08/555,400 is a continuation-in-part of application No. 08/232,862, filed on Apr. 25, 1994, now Pat. No. 5,489,103.

(30) Foreign Application Priority Data
Oct. 5, 1993 (JP) 5-108303

(51) Int. Cl. A63F 9/24; G06F 17/00; G06F 19/00; A63F 13/00

(52) U.S. Cl. 463/29; 434/307 A

(57) ABSTRACT

A system and method for controlling use of program related element in a user system wherein a program related element includes at least one of a program, data or a combination of a program and data. An authorization key controlling access by the user system to the program related element is stored in a host facility, together with an associated access definition including a period of use definition defining a period in which the user system may access the program related element. Upon receiving a request for access to the program related element by a user system, and depending upon the requirements of the associated access definition, the host system communicate the authorization key and at least parts of the associated access definition to the user system. The user system, in turn, will respond to the authorization key and to the accompanying parts of the associated use definition by allowing the user system access to the program related element in conformance with the accompanying parts of the associated use definition.

This is a Continuation-in-Part of Ser. No. 09/109,784 filed Jul. 2, 1998 which is a Continuation-in-Part of Ser. No. 08/642,560 filed May 3, 1996 which is a Divisional of Ser. No. 08/555,400 filed Nov. 9, 1995 which is a Continuation-in-Part of Ser. No. 08/232,862 filed Apr. 24, 1994.

### FIELD OF THE INVENTION

This invention relates to an interactive communication system for transmitting video game and karaoke software from a host facility to communication terminal devices.

### BACKGROUND OF THE INVENTION

Video games have become a very popular form of family entertainment. In order to play a video game, a game cassette is first installed in a video game machine body. Game data, contained in the cassette including video information and usually audio information, is read and outputted to a common television receiver. Accordingly, the one who wishes to play a video game must have a video game machine and a game cassette, besides a television set. Once the game cassette is installed, the player can play the game whenever and as many times as the player wishes.

However, therein lies a problem: the player has to purchase each and every game cassette he wishes to play, which can be very costly. For all the advantage that the player can play the game repeatedly, he may soon get tired of the game, or the game content may not be oriented for repeated play.

Another form of entertainment increasing in popularity is “karaoke”, i.e. singing to recorded instrumental accompaniment. More and more “karaoke bars” can be seen in major cities, and karaoke machines for domestic use are becoming widely accepted. Such family karaoke machines need, by definition, karaoke music software, which can be found, for example, on video disk, video tape containing video and audio information, and music tape containing only audio information. Karaoke singers, tempted by changing trends in music, tend to purchase newly available karaoke programs, one after another. Thus, there arise problems of accumulated expenditure and limited storage space for the increasing number of karaoke programs.

### SUMMARY OF THE INVENTION

Wherefore, an object of this invention is to provide an interactive communication system in which video game and karaoke software is transmitted via communication lines from a host facility to a calling communication terminal device at each individual home.

In order to attain the stated object, a communication terminal device according to the present invention includes communication means, connected to communication lines, for sending out or receiving data, and a computer for outputting control instructions to the communication means, and outputting or inputting data to or from the communication lines via the communication means. The communication terminal device further includes temporary storage means for temporarily storing the data inputted from the communication lines if the data inputted is game data including video information or video plus audio information, and game data outputting means included in the computer, for outputting, if the data stored in the temporary storage means is game data, the game data to integral or external display means, and, if the game data also includes audio information, to integral or external sound generating means.

In this way, the computer controls the communication means by supplying control instructions thereto. Data is thus sent out, under the control instructions thereto. Data is thus sent out, under the control by the computer, via the communication means and the communication lines, or received via the communication lines and the communication means.

From another aspect of the invention, the computer may also include a printer, provided on the computer or provided externally, whereby, the data stored in the computer can be printed. For example, when the player wishes to quit game play, the current status of the game progress, e.g. which player corresponds to which character in the game, or the top scorer at the time, can be stored. When resuming the game, the player can refer to the printed data.

From still another aspect of the invention, a communication system according to the present invention includes the above described communication terminal device and a host facility intercommunicably connected to the communication terminal device. When the communication terminal device requests the host facility to provide game data, the host facility sends out the corresponding game data to the communication terminal device via the communication lines. The game data, received at the communication terminal device, is temporarily stored in the temporary storage means.

From a further aspect of the invention, the game data stored in the temporary storage means is deleted after a predetermined amount of time passes after the game data was received at the communication terminal device. In order to effect this deletion, the communication terminal device may include control means which operates, responsive to receipt of the game data, to delete the game data after a predetermined time period. Alternatively, the host facility may send an instruction concerning the time period, in addition to each game data it sends out. The latter alternative permits alteration of the time period with respect to each game.

By utilizing the communication system, the player need not purchase a game cassette or other software for playing video games, since the game data is provided by the host facility, which received the game data request sent by the player from his communication terminal device. Further, the game data provided to the player is temporarily stored in the temporary storage means of the communication terminal device, thereby releasing the host facility to serve other communication terminal devices requesting game data. The host facility is thus able to respond to a greater number of callers having communication terminal devices.

Furthermore, the game data stored in the temporary storage means is deleted in a predetermined time period after it was received at the communication terminal device. In other words, the useful life of the game data at the communication terminal devices is limited. As a result of this arrangement, in order to continue the game play at the end of the predetermined time period, the player again needs to request the game data from the host facility. This arrangement is, therefore, prerequisite so long as the game data transmission service is not free of charge. In contrast, if it were possible to keep the game data at the communication terminal device at the end of game play, the player could play the game permanently without calling the host facility. Consequently, the service cost per each transmission would be higher than the normal price of the game cassettes. The above described arrangement solves this problem and meets the need of software distributors.

The arrangement is also beneficial to players since the service cost per each transmission can be considerably lower than the price of each game cassette. Therefore, the game player who conventionally has to buy an expensive game cassette, even if he plays the game only once, can be satisfied with the reasonable cost of the transmission. The arrangement is also superior with respect to child discipline, since children can only play a limited time.

From still another aspect of the invention, the communication terminal device according to the present invention may be adapted for karaoke.

When the data input from the communication lines is a karaoke data, the temporary storage means temporarily stores the karaoke data, which is then outputted to a sound output device. The sound output device may be provided on the communication terminal device or provided externally. If the karaoke data also includes video information, the karaoke data is also output to a display. The display may also be provided on the communication terminal device or provided externally.

The communication system according to the present invention includes the above described communication terminal device and a host facility intercommunicably connected to the communication terminal device. Karaoke data is sent and received in a manner similar to the one described above for video games. The system may be configured so that the karaoke data is erased after a certain time period.

In further embodiments, the present invention is directed to a method and apparatus for controlling use of program related element in a user system wherein a program related element includes at least one of a program, data or a combination of a program and data.

In these further embodiments, an authorization key controlling access by the user system to the program related element is stored in a host facility, together with an associated access definition including a period of use definition defining a period in which the user system may access the program related element. Upon receiving a request for access to the program related element by a user system, and depending upon the requirements of the associated access definition, the host system communicate the authorization key and at least parts of the associated access definition to the user system. The user system, in turn, will respond to the authorization key and to the accompanying parts of the associated use definition by allowing the user system access to the program related element in conformance with the accompanying parts of the associated use definition.

According to this embodiment, the program related element may be resident in the user system, loaded into the user system from a host system or transmitted into the user system from a second user system.

In addition, the authorization key may be an unlocking key, whereupon the user system is responsive to the unlocking key for permitting access to the program related element, or a decryption key, wherein the program related element is encrypted and the user system is responsive to the decryption key to decrypt the program related element to provide the decrypted program related element to the user system. If the authorization key is a decryption key, the program related element may be generated and encrypted in a second user system, a decryption authorization key and associated access definition generated and stored in the host facility in association with the generation and encryption of the program related element, and the program related element transmitted to the user system independently of the host system.

In further aspects of such an embodiment of the invention, the access definition may include at least one of a start date/time and an end date/time, thereby defining a period in which access to the program related element is permitted. The access definition may also include at least one use period defining a period during which the user system may access the program related element wherein the user system access to the program related element terminates at the expiration of the user period. The access definition may also include conditions to be satisfied before the user system may access the program related element.

Other objects, advantages and novel features of the invention will become apparent from the following detailed description of the invention when considered in conjunction with the accompanying drawings, in which like reference characters designate the same or similar parts through the figures thereof.

### BRIEF DESCRIPTION OF THE DRAWINGS

FIG. 1 is a block diagram of a communication terminal device according to the present invention;

FIG. 2 is a block diagram of a communication system including the communication terminal device shown in FIG. 1;

FIG. 3 is a flowchart of the process to call a host facility;

FIG. 4 is an example of screen display in accordance with the method of operation selection in the embodiment;

FIG. 5 is an example of screen display in accordance with the method of further operation selection in the embodiment;

FIG. 6 is a flowchart of the process to be effected when playing a game is requested at the communication terminal device;

FIG. 7 is a flowchart of the process to effect deletion of the game data;

FIGS. 8A through 8D are illustrations showing various forms of modified interference means which interfere with the progress of a game;

FIG. 9 is a flowchart of the game data deletion/restoration process;

FIG. 10 is a block diagram schematically showing the system consisting of a host facility and the communication terminal device for receiving the game data from the host facility via wireless transmission;

FIG. 11 is a block diagram schematically showing the system consisting of a broadcasting station and the communication terminal device for receiving the game data from the broadcasting station;

FIG. 12 is a flowchart showing another embodiment;

FIGS. 13, 14 and 15 are flowcharts showing further embodiments.

### DESCRIPTION OF THE PREFERRED EMBODIMENTS

In the embodiment of the invention, data, a program, or a combination of the two is transmitted from a host facility to a communicator as a communication terminal device. The data can be game data for playing games, karaoke data for playing karaoke music, image data for displaying static images like still pictures or dynamic images like movies, audio data for reproducing sound of playing music, character data for composing documents, and the like. The program includes a large-scale program, such as a program for word processing, a program for computing with a spread sheet, or a program for communication, and a plug-in-program to be incorporated in a main program. Transmitting a combination of the program and data means, for instance, transmitting a karaoke executing program and the data indicative of karaoke music to be played, or a set of a word processing program and the data indicative of document examples.

In the embodiment of the invention, when a predetermined time has elapsed after the host facility sends out the transmission to the communicator, the data or the program becomes unusable, preferably after a warning has been given. It is also preferable to have a way to resume the use in accordance with the user's instruction, even after the data or program becomes unusable.

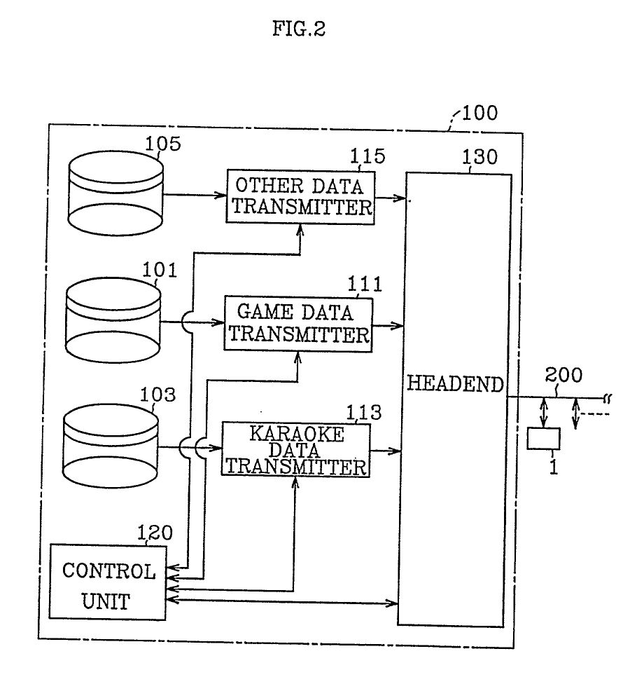

As shown in FIG. 2, the communication system according to the present invention includes a host facility 100, a personal communicator 1 as a communication terminal device, and transmission paths 200 as communication lines.

The host facility 100 has game data base 101, karaoke data base 103 and other data base 105. The host facility 100 also has game data transmitter 111, karaoke data transmitter 113 and other data transmitter 115 tp retrieve data from corresponding data base and transmit them. The host facility 100 further has control unit 120 to control the transmitters 111, 113 and 115, and a headend 130 to output or input signals.

When a request data is sent out from the personal communicator 1 via the transmission paths 200, the request data is received through the headend 130 and input by the control unit 120. The control unit 120 then controls one of the transmitters 111, 113 and 115 to retrieve data corresponding to the request, and the retrieved data is sent out via the headend 130 to the transmission paths 200.

The transmission paths 200 are coaxial cables and connected to a plurality of personal communicators 1.

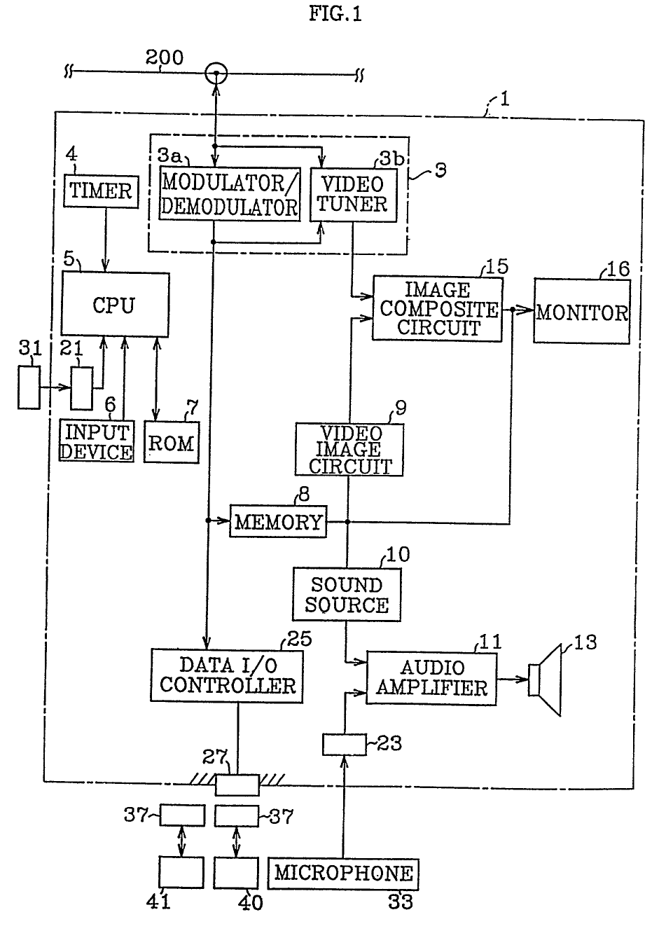

As shown in FIG. 1, the personal communicator 1 includes a terminal modem 3, timer 4, CPU 5, input device 6, ROM 7, memory 8, video image circuit 9, sound source 10, audio amplifier 11, speaker 13, image composite circuit 15, monitor 16, controller connector 21, microphone connector 23, data input/output controller 25 and data input/output connector 27.

The terminal modem 3 is connected to the transmission paths 200 and includes modulator/demodulator 3a and video tuner 3b which selects a channel of the image to be projected.

The input device 6 may be a keyboard or mouse, and is used for inputting a designation of a desired game or karaoke data or other instructions. When a controller 31, which is exclusively used for playing video games, is connected to the controller connector 21, the controller 31 can be operated only for playing games. The controller 31 is provided with joy sticks or other control buttons commonly provided on conventional video game machines.

By connecting a microphone 33 to the microphone connector 23, the user can have his voice output to the speaker 13.

The data input/output connector 27 is connected via data output cable 37 to a printer 40, personal computer 41, or other apparatus.

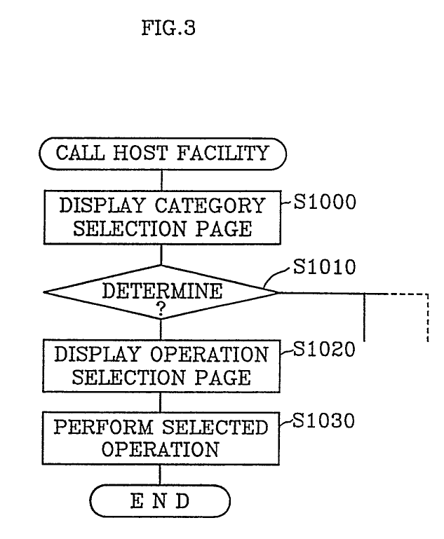

The operation effected on the CPU 5 will be now explained referring to the flowchart of FIG. 3.

When power is supplied, a main menu is displayed, offering various selections, including “call host facility”, which is selected by a user.

First, category selection pages are displayed at step S1000. The display includes the instruction of “select a category” and a list of available categories such as game and karaoke. The selected category is next determined at step S1010. Subsequently, an operation selection page corresponding to the selected category is displayed at step S1020. The display of the operation selection page includes an instruction to the operator and the list of available operations in the selected category. When the operator inputs direction responsive to this instruction, the corresponding respective operation process is performed at step S1030. In preparation for the respective operation process, the personal communicator 1 is connected to the host facility 100 such that the interactive communication can be performed between the personal communicator 1 and the host facility 100.

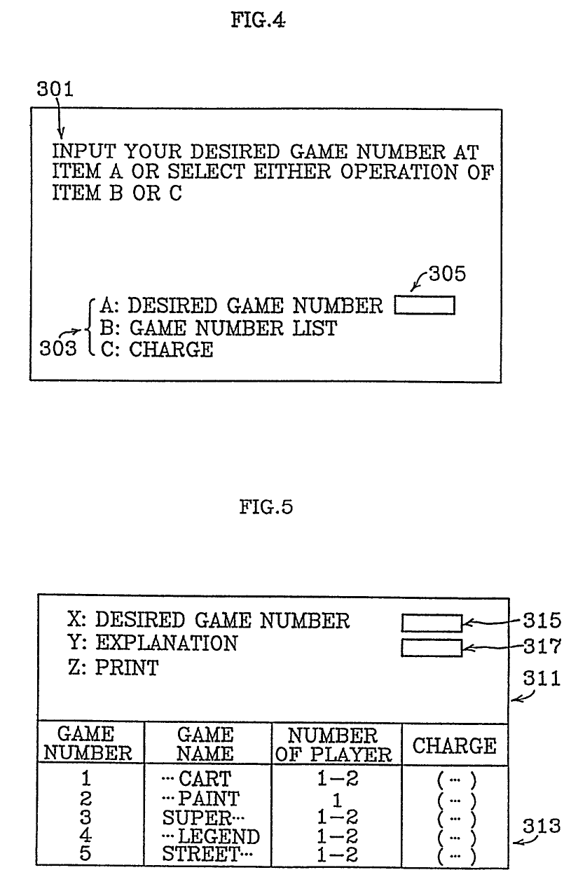

The above procedure is further explained in detail, only for exemplification purpose, hereinafter referring to FIGS. 4, 5 and 6.

When “game” category is selected at step S1000, operation selection page shown in FIG. 4 is displayed, with an instruction 301 and operation list 303 shown on the screen. The operation list has three items of item A, item B and item C. Item A has a first game number box 305, into which the operator can directly input a game number representative of a specific game the operator desires to receive. Item B is the operation to display the list of the game numbers now available from the game data base 101 of the host facility 100. Item C is the operation to display charges, for example the accumulated cost for the month or the past month(s).

When the operator wishes to play a game, item A or B is selected. For example, if the operator knows the game number of the game he wishes to play, the operator moves the cursor on the screen to the first game number input box 305, and inputs the desired game number therein. If the operator does not know the game number, he selects item B.

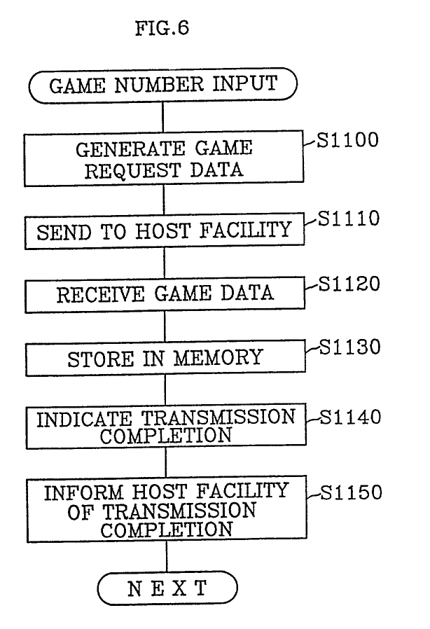

When item B is selected, data in the form of the list of game numbers is sent from the host facility 100 and displayed on the screen. As shown in FIG. 5, the list displayed by selecting item B has an input part 311 and display part 313. The display of the game list 313 can be scrolled to display further the list of games. The display part 313 displays the number of players able to participate in the play and the charge, in addition to the game numbers and the game name. The operator, referring to this information on the screen, inputs his desired game number into a second game number input box 315 of the input part 311.

When selecting a game for the first time, the operator may wish to know the feature or outline of the game. In this case, the operator inputs the selected game number into an explanation box 317 of item Y of the input part 311. As a result, the outline of the game is explained on the display part 313.

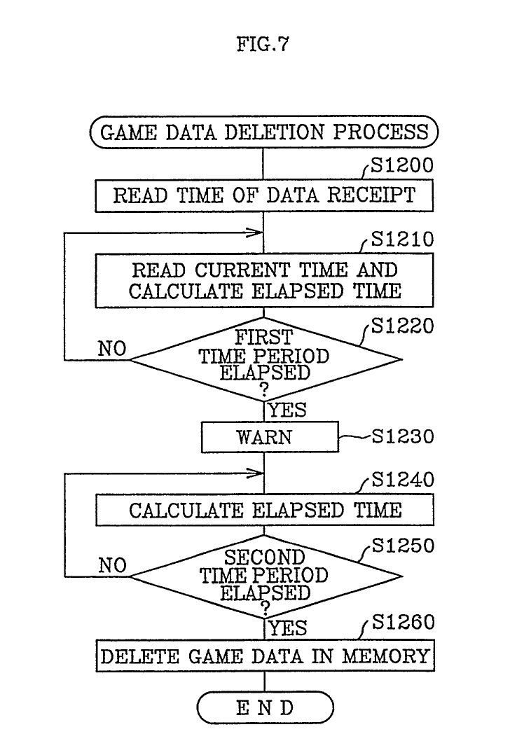

The game list can be printed out such that the operator can refer to the printed game list when he selects a game on other occasions. For printing, item Z of “print” in the input part 311 is selected. In response, the game list is printed, via the data input/output connector 27 and data output cable 37 shown in FIG. 1, at the printer 40. The process which is effected when a game number is input in the first game number box 305 of item A shown in FIG. 4 or in the second game number box 315 of item X shown in FIG. 5 will now be explained referring to FIG. 6.

First, game request data is generated at step S1100. The game request data includes the identification number of the calling personal communicator 1 and the desired game number. The generated game request data is then sent out to the host facility 100 at step S1110.

At the host facility 100, the received request data is input by the control unit 120 through the headend 130. Subsequently, game data corresponding to the request is retrieved from the game data base 101 by the game data transmitter 111. The retrieved game data is sent out via the headend 130 to the transmission paths 200 and to the corresponding personal communicator 1. First, second, and third predetermined time periods, which will be described later in detail, are also sent out to the personal communicator 1.

Turning back to FIG. 6, the game data is received at the personal communicator 1 at step S1120 and stored in the memory 8 at step S1130. When the storage of the game data into the memory 8 is completed, the completion is indicated on the monitor 16 at step S1140. Further, data indicative of the completion of the game data transmission is sent out to the host facility 100 at step S1150 as the last step of the instant process step, and the personal communicator 1 awaits the next operation. When, for example, game play is instructed as the next operation, the game stored in the memory 8 is started.

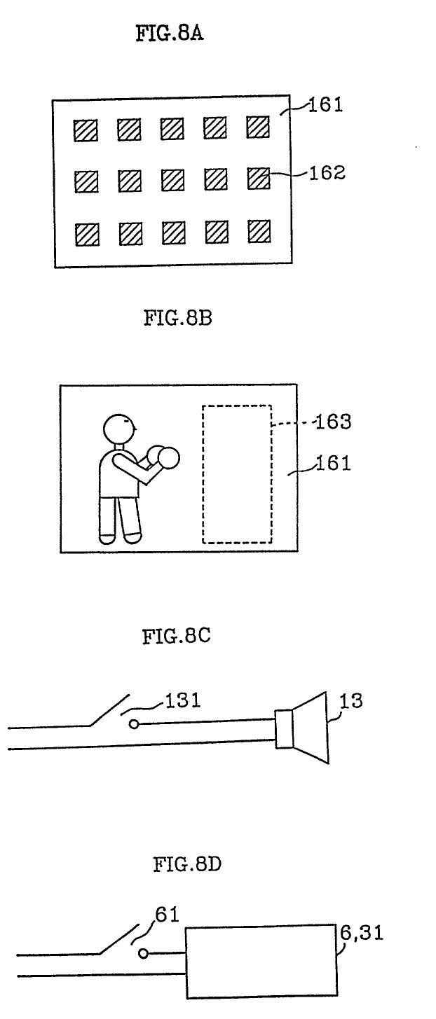

The game data received by the process shown in FIG. 6 and the game data stored in the memory 8 is automatically deleted, as shown in the flowchart of FIG. 7, in the following manner. First, the time when the data receipt is completed is read out at step S1200. The current time is also read out and the time period which has elapsed after the completion of the data receipt is calculated at step S1210. Next, it is determined, at step S1220, whether or not a first predetermined time period has elapsed. If “NO” is determined at the step S1220, the flow goes back to the step S1210. Thus, when the first predetermined time period has elapsed, a warning is given at step S1230. Further elapsing time period is calculated at step S1240. When it is determined, at step S1250, that a second predetermined time period has elapsed, the game data stored in the memory 8 is deleted at step S1260, and the instant process ends.

The warning given at step S1230 may be a various form of warning, such as a message reading “Time Out in Five Minutes!” on the monitor 16, or an alarming sound. Therefore, the total of the first predetermined time period of the step S1220 and the second predetermined time period of the step S1250 is the useful life period of the received game data. The warning may be provided a plurality of times, such as five minutes, two minutes and one minute before the deletion of the game data. Warned by this warning, the player can print the current status of the game progress, for example, which player corresponds to which character in the game or the top scorer at the time, at the printer 40 before quitting the game play. The printed data is useful when the player resumes the game play.

Furthermore, when the host facility 100 receives the data indicative of the transmission completion at the step S1150, the host facility 100 performs the charging process to accumulate the cost for its data transmission service. There are two known cost charging systems. One is the fixed amount system and the other is the pay-per-play system. In the fixed amount system, the fixed cost amount per-time period, for example monthly, is predetermined. In the pay-per-play system, the cost is charged per each play.

The charging system is dependent on the form or condition of the communication service to be rendered. In a practical charging system, the cost would be varied with respect to the complicatedness or scale of the game data provided. The cost would also vary depending on whether the game is new or old in the market. In the present embodiment, the pay-per-play system is adopted and the cost for the data service to each terminal communicator is charged every time the data indicative of the transmission completion is sent from the personal communicator 1 at step S1150. The payment would be made, using the automatic transfer system, by debiting the amount to the bank account of the players.

However, the pay-per-play system has a problem: the player cannot know the total amount of the accumulated cost before actual payment. If the payment is made using the automatic transfer system, the player may not even notice his considerable expenditure on the game play. This problem is solved by the arrangement shown in FIG. 4. If the player selects item C of the operation list 303, the present accumulated cost and the previous cost, such as the payment made previously or the cost accumulated in the past half or whole year, are shown on the screen. Thus, parents can know the accumulated cost of their child's video game play.

By utilizing the communication system, the player need not purchase a game cassette or other software for playing video games, since the game data is provided by the host facility which received the game data request sent by the player from his personal communicator 1. Further, the game data provided to the player is temporarily stored in the memory 8 serving as temporary storage means of the personal communicator 1, thereby releasing the host facility to serve other personal communicators 1 requesting game data. The host facility is thus enabled to respond to a greater number of callers having personal communicators 1.

Furthermore, the game data stored in the memory 8 is deleted in a predetermined time period after it was received at the personal communicator 1. In other words, the useful life of the game data at the personal communicator 1 is limited. As a result of this arrangement, in order to continue the game play at the end of the predetermined time period, the player again needs to request the game data from the host facility 100. This arrangement is, therefore, prerequisite so long as the game data transmission service is not free of charge. In contrast, if it were possible to keep the game data at the communication terminal device at the end of game play, the player could play the game permanently without calling the host facility 100. Consequently, the service cost per each transmission would be higher than the normal price of the game cassettes. The above described arrangement solves this problem and meets the need of the software distributors.

The arrangement is also beneficial to the players since the service cost per each transmission can be considerably lower than the price of each game cassette. Therefore, the player who conventionally has to buy an expensive game cassette, even if he plays the game only once, can be satisfied with the reasonable cost of the transmission.

The arrangement is also superior with respect to child discipline. Video game players are in most cases younger children, who often become too absorbed in playing video games to quit in the middle thereof. The above arrangement according to the present invention leaves these children no other choice but to quit the play when a predetermined time period has elapsed. Thus, the arrangement meets the rising demand of parents.

The above embodiment is explained on the premise that the game is played by a single player using only a single personal communicator 1. However, a plurality of players in remote places can play the same game together.

For example, the transmission paths 200 or telecommunication lines is utilized to connect a plurality of personal communicators 1 to one another such that the interactive communication can be performed therebetween. When the plurality of personal communicators 1 are supplied with the same game data, the players have the same game characters in common. Therefore, the data to be transmitted among the plurality of personal communicators 1 are only character number data and the position data. Thus, the players together participate, on a real time basis, in the same game on the monitor 16 of respective personal communicators 1.

Map data of a role-playing game may be divided according to the progress degree of the story and the divided map data be sold separately. When the game progresses and the player wishes to play on a more advanced map data, the player purchases and downloads the advanced map data. In this case, arrangement is provided such that the player cannot purchase the advanced map data until the “capacity” or the progress degree of the characters in the game reaches a predetermined degree or level. Accordingly, using the interactive communication system, the player is to ask the host facility 100 for the proof of the capacity. In response, data proving the capacity or level of the characters may be transmitted from the host facility 100. The capacity proof sent from the host facility 100 would be printed out by the printer 40 or transmitted to the player's facsimile machine, as a certificate.

It will now be explained how the communication system of the present invention is adopted to karaoke. The procedure to communicate the karaoke data is basically similar to the above described procedure to communicate the game data. Therefore, the explanation of the similar portion of the procedure are omitted for simplification. When using the system for karaoke, the microphone 33 is connected to the microphone connector 23 of the personal communicator 1.

When “karaoke” is selected on the category selection page at step S1000, an operation selection page similar to that of FIG. 4 is displayed on the screen. Specifically, an item A of a desired karaoke number, item B of the karaoke number list, and item C of charge are displayed. If the operator wishes to start karaoke, the operator inputs the desired karaoke number in the corresponding box at item A or B.

Karaoke request data is then generated at the personal communicator 1 and sent out to the host facility 100. The host facility 100, receiving the request, controls the karaoke data transmitter 113 to retrieve corresponding karaoke data from the karaoke data base 103, and sends out the retrieved karaoke data to the personal communicator 1.

The karaoke data received at the personal communicator 1 is stored, as song data, in the memory 8 via the modulator/demodulator 3a. At the same time, the CPU 5 sends song selection data, which is predetermined according to the type of each song, to the video tuner 3b in order to select visual data suitable to the selected song. Further, the CPU 6 synchronously outputs to the video image circuit 9 and the sound source 10, respectively, words data and accompaniment data included in the song data stored in the memory 8. The video image circuit 9 converts the information concerning the words and other elements of the song into word/image data and outputs the word/image data to the monitor 16.

The sound source 10 converts the accompaniment data into audio signals, and outputs the audio signals to the audio amplifier 11. Subsequently, the audio amplifier 11 synthesizes the audio signals and the voice signals sent from the microphone 12, amplifies these synthesized signals and outputs them to the speaker 13 as sound signals. The video tuner 3b reads out background visual data selected according to the song selection data, and outputs to the image composite circuit 15. Then, the image composite circuit 15 synthesizes the background visual data and the words/image data and outputs the video signals to the monitor 16.

The procedure for playing karaoke music will be further explained in detail.

The song data sent out from the host facility 100 via the coaxial cables as transmission paths 200 includes multiplied RF signals of video information and RF signals converted from the song data. The CPU 5 of the personal communicator 1 sends the song selection data to the video tuner 3b of the terminal modem 3 in order to select the video channel according to the received song data. The song selection data is predetermined according to the genre of songs. Consequently, the song data is sent to the sound source 10 and the karaoke music is played.

When the karaoke music is ended, data indicative of the end of the play is sent to the host facility 100. In response, the host facility 100 performs the charging process. In contrast to the pay-per-play system of the game data service, the cost for providing the karaoke music may be charged, for example per hour, since a single piece of karaoke music is only several minutes long.

In the case of karaoke data, as in the case of game data, a predetermined time is counted after the karaoke data is received from the host facility, and when the predetermined time has elapsed, the karaoke data is deleted.

By utilizing the communication system, the karaoke singer need not purchase a video disk or other karaoke software, since the karaoke data is provided by the host facility 100, which received the karaoke data request sent by the karaoke singer from his personal communicator 1. Further, the karaoke data provided to the karaoke singer is temporarily stored in the memory 8 serving as temporary storage means for the personal communicator 1, thereby releasing the host facility 100 to serve other personal communicators 1 requesting karaoke data. The host facility 100 is thus able to respond to a greater number of callers having personal communicators 1. This invention has been described above with reference to the preferred embodiment as shown in the drawings. Modifications and alterations may become apparent to one who is skilled in the art upon reading and understanding the specification. Despite the use of the embodiment for illustration purposes, it is intended to include all such modifications and alterations within the scope and spirit of the appended claims.

In this spirit, it should also be noted that in the embodiment, the personal communicator 1 is integrally provided with the monitor 16 and the speaker 13. However, any other external monitor or speaker may be connected to the personal communicator 1 and utilized. For example, a television receiver may be connected to the personal communicator 1, thereby outputting the video information and the audio information on the television receiver. In this case, the personal communicator 1 may be provided with a small display, on which the selection pages as those shown in FIGS. 4 and 5 would be displayed.

Furthermore, the transmission paths 200 may be existing coaxial cables for cable television system, thereby structuring the communication system of the present invention as a multimedia interactive communication system. In this way, the video and audio information of satellite television services, video disks, radio programs, and other various forms of available software are equated to the other data base shown in FIG. 2. Such personal communicators 1 of the present invention can be provided in each individual's home or hotel room and in other various situations and places.

As mentioned, the stored data is deleted in a predetermined time period after it was received. This arrangement is beneficial to the data distributors since repeated game or karaoke play using the same game data or karaoke data is prevented..

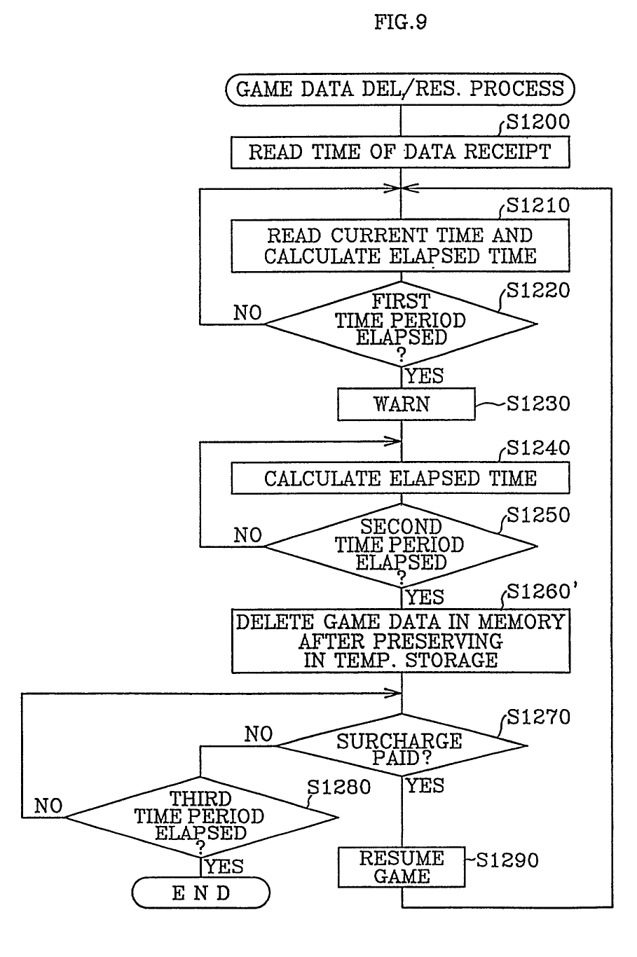

In the above described embodiment, the game data stored in the memory 8 is deleted in order to interfere with the progress of game. Alternative arrangements to this are provided by the present invention, as shown in FIGS. 8A through 8D. In the arrangement of FIG. 8A, the view on a screen 161 of the monitor 16 is blocked with patterns of stripes 162 displayed thereon. Instead, the view displayed on the screen may be partly deleted. In the arrangement shown in FIG. 8B, only an opponent of a boxing game, who is to be displayed on an area 163 of the screen 161, is deleted. Still another alternative is provision of a switch 131 shown in FIG. 8C for a speaker circuit, which, when turned off, withholds the sound that would otherwise be issued from the speaker 13 during the game. Further alternative is provision of a switch 61 shown in FIG. 8D or the controller 31. The switches 131 and 61 may be mechanical components or may be software operations. For instance, actuation of the sound source 10 may be halted by the CPU 5, or the CPU 5 may reject signals from the input device 6 or the controller 31. As still another alternative, the power of the personal communicator may be turned off when the CPU 5 determines that a predetermined time has elapsed after the game data was received.

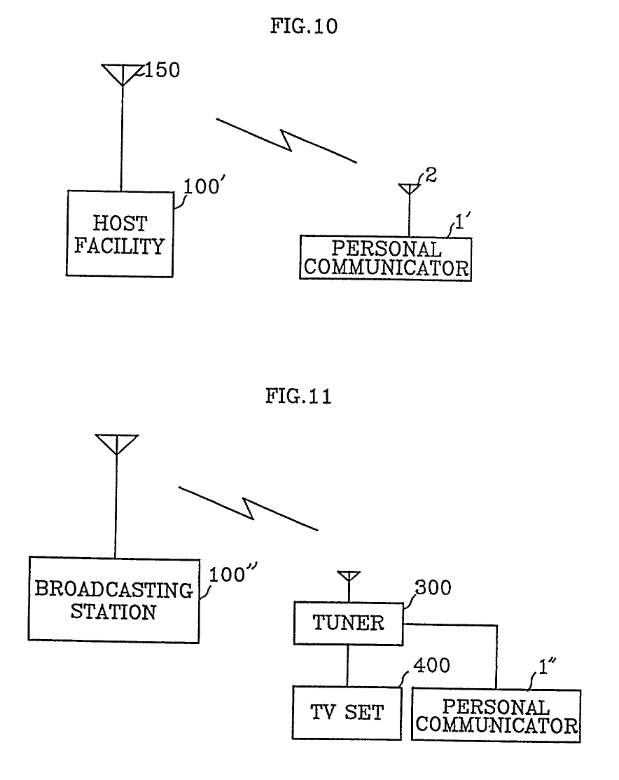

In the described embodiment, when a predetermined time has passed after the game data was received from the host facility 100, the game data stored in the memory 8 is deleted. However, it may be arranged so that the player can resume playing the game by paying a surcharge. Specifically, the process steps shown in FIG. 9 may be taken. As will be noted, the process steps S1200 through S1250 in FIG. 9 are identical to those in FIG. 7, whereas at step S1260′ the deletion of the game data is effected only after it is stored in a temporary storage device, different from the process at step S1260. At next step S1270, it is determined whether or not a surcharge has been paid. If the answer to the step S1270 is negative, it is next determined, at step S1280, whether or not a predetermined time has elapsed after the game data in the memory 8 was deleted. If the answer to the step S1280 is negative, the flow returns to step S1270. If the answer to the step S1280 is affirmative, the process step ends.

If “YES” is determined at the step S1270, the game data stored in the temporary storage device is restored into the memory 8 to permit resumption of game play, at step S1290. The flow then goes back to step S1210. In the process after the resumption of game play, the elapsed time after the time of paying the surcharge is calculated at step S1210.

The arrangement shown in FIG. 9 allows a player to continue playing a game as long as the player pays a surcharge. An instruction to pay the surcharge can be given through the keys on the input device 6. In response, the host facility 100 effects the charging process against the player.

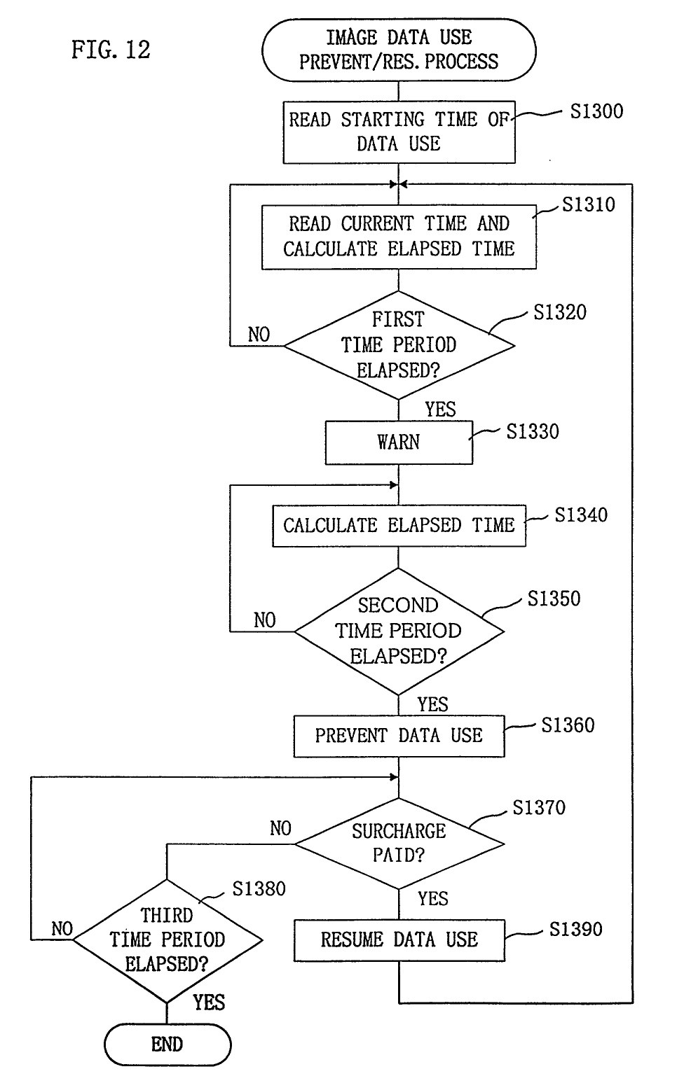

In the embodiment shown in FIGS. 1 and 2, game data and karaoke data are transmitted via communication lines, which may be public telephone lines, dedicated communication lines, cables for community antenna television system. Instead of such communication lines, as shown in FIG. 10, the data may be sent via wireless transmission from a host facility 100′ to a personal communicator 1′. In this case, the host facility 100′ is provided with a not-shown wireless transmission circuit including a transmitting/receiving antenna 150, and the personal communication 1′ is provided with a not-shown transmitter/receiver circuit including a transmitting/receiving antenna 2.

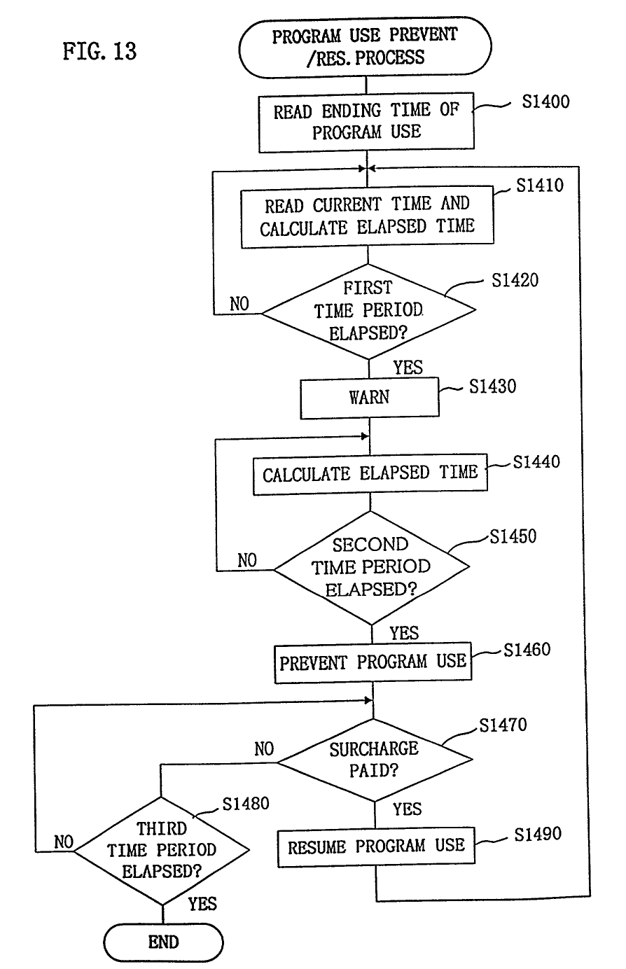

Turning to FIG. 11, a further modification is proposed in which the game data is sent from a ground broadcasting station 100″ or a satellite broadcasting station. The game data, as it is received, is stored in the memory 8 of the personal communicator 1″. In this case, the personal communicator 1″ is connected with a tuner 300 so that the game is displayed on a screen of a home television set 400. Alternatively, the broadcasting may be performed preferably via two-way communication through cables, or via Internet. In the communication system disclosed in this specification, the data to be transmitted may be either analog or digital.

In both modifications shown in FIGS. 10 and 11, the game play in interrupted when a predetermined time has elapsed after the game data was received at the personal communicators 1′, 1″. Of course, the arrangement shown in FIG. 9 may be incorporated into these arrangements of FIGS. 10 and 11 to allow the player to continue playing a game by paying a surcharge.

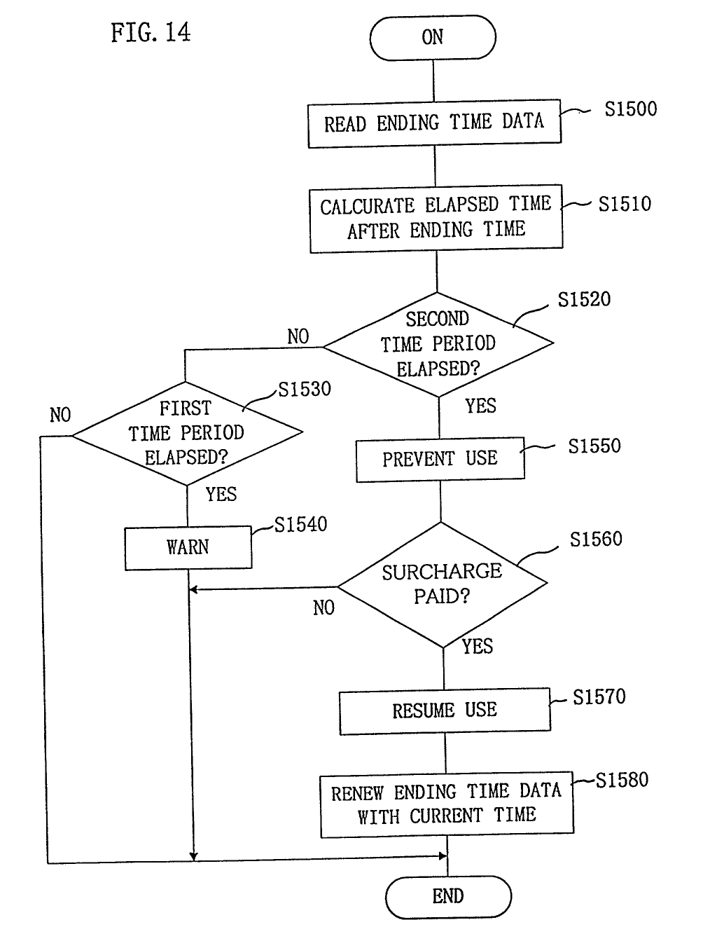

FIG. 12 is a flowchart showing another embodiment. In this embodiment, a predetermined time period to prevent further use of the image data is counted from the starting time of use of the data, not from the receiving time of the data from the host facility.

This embodiment is explained in detail hereinafter referring to FIG. 12. When the use of the image data sent from the host facility starts, the starting time is read out at step S1300. The current time is also read out, and the elapsed time after the starting time is calculated at step S1310. Then it is determined, at step S1320, whether or not a first predetermined time period has elapsed. If “NO” is determined at step S1320, the flow returns to step S1310. If “YES” is determined, a warning is given at step S1330, and the elapsed time continues to be calculated at step S1340 until the end of a second predetermined time period. When it is determined, at step S1350, that the second predetermined time period has elapsed, a process to prevent further use of the above image data is performed at step S1360. There may be various means to prevent further use of the image data, such as deleting the image data stored in the memory 8, blocking, as shown in FIG. 8A or 8B, the view on the screen of the monitor 16 in accordance with the progress of the image data processing, stopping, as shown in FIG. 8C, the sound generated in accordance with the progress of the image data processing and invalidating, as shown in FIG. 8D, any operation of the input device 6 or the controller 31 for instruction.

At next step S1370, it is determined whether or not a surcharge is paid. If the answer to step S1370 is negative, it is next determined, at step S1380, whether or not a third predetermined time has elapsed after the process to prevent further use of the image data is performed. If the answer to step S1380 is negative, the flow returns to step S1370. If the answer to step S1380 is affirmative, the process step ends.

If “YES” is determined at step S1370, the image data is permitted to be continuously used at step S1390, then the flow returns to step S1310. In the process after the resumption of use, the elapsed time after the payment of the surcharge is calculated at step S1310. In the case where deletion of the image data stored in the memory is used as a means of preventing further use of the image data, it is preferable to preserve the image data in a not-shown temporary storage device before deleting it from the memory, and to restore it from the temporary storage device into the memory after the surcharge is paid.

As in the above embodiment, instructions to pay the surcharge can be given by operating the keyboard of the communicator 1, and in response to the key operation, the host facility 100 performs the charging process.

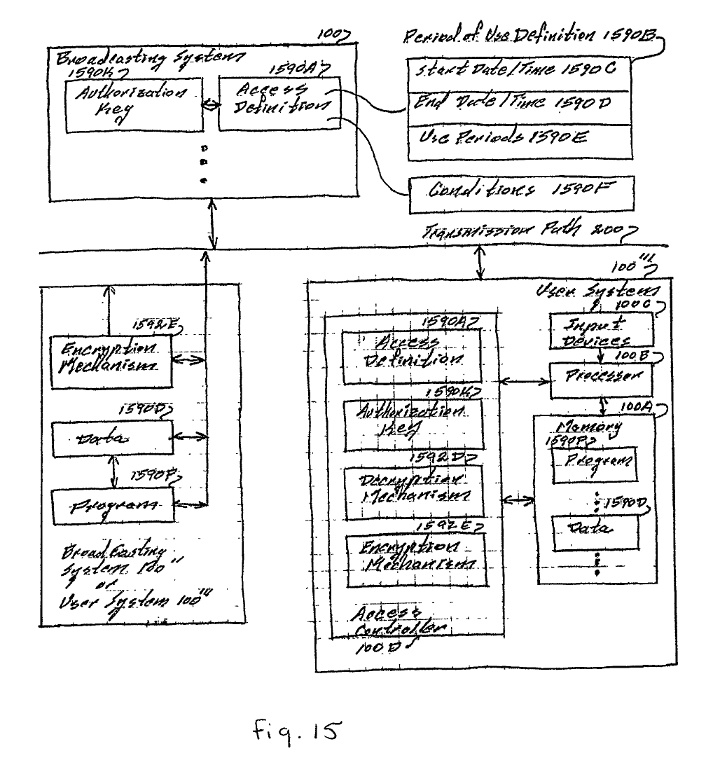

FIG. 13 is a flowchart of a further embodiment. In this embodiment, when the program sent from the host facility is continuously unused for a predetermined time period, a process to prevent further use of the program is performed.

The procedure of this embodiment is explained in detail, hereinafter referring to FIG. 13. When the program sent from the host facility is used for some time and then the use ends, the ending time is read out at step S1400. Next, the current time is also read out and the elapsed time after the ending time is calculated at step S1410. Then it is determined, at step S1420, whether or not a first predetermined time period has elapsed. If “NO” is determined at step S1420, the flow returns to step S1410. If “YES” is determined, a warning is given at step S1430, and the elapsed time continues to be calculated at step S1440 until the end of a second predetermined time period. When it is determined, at step S1450, that the second predetermined time period has elapsed, a process to prevent further use of the above program is performed at step S1460. There may be various means to prevent further use of the program, such as deleting the program stored in the memory 8, blocking, as shown in FIG. 8A or 8B, the view on the screen of the monitor 16 in accordance with the progress of the program, stopping, as shown in FIG. 8C, the sound generated in accordance with the progress of the program, and invalidating, as shown in FIG. 8D, any operation of the input device 6 or the controller 31 for instructions.

At next step S1470, it is determined whether or not a surcharge is paid. If the answer to step S1470 is negative, it is next determined, at step S1480, whether or not a third predetermined time has elapsed after the process to prevent further use of the program is performed. If the answer to step S1480 is negative, the flow returns to step S1470. If the answer to step S1480 is affirmative, the process step ends.

If “YES” is determined at step S1470, the program is permitted to be continuously used at step S1490, then the flow returns to step S1410. In the process after the resumption of use, the elapsed time after the payment of the surcharge is calculated at step S1410. In the case where deletion of the program stored in the memory is used as a means of preventing further use of the program, it is preferable to preserve the program in a not-shown temporary storage device before deleting it from the memory and to restore it from the temporary storage device into the memory after the surcharge is paid.

As in the above embodiment, instructions to pay the surcharge can be given by operating the keyboard of the communicator 1, and in response to the key operation, the host facility 100 performs the charging process.

If the program is used while a process shown in FIG. 13 is in progress, the above process is ended by a not-shown interrupt handling, and at the next cycle time the process at step S1400 starts again.

In the embodiments shown in FIG. 13, the elapsed time period, during which a program is continuously unused, is preferably counted in the background by a backup power source even when the power of the personal communicator 1 is off. The processes to give a warning and to prevent further use may be performed when the power switch of the personal communicator 1 is turned on next time.

In addition to the above described case, it may be considered that the elapsed time is calculated each time the power switch of the personal communicator 1 is turned on. Such an embodiment is shown in FIG. 14. In this embodiment, concerning each program or data stored in the memory 8, the ending time of use of the program or the data is stored in a specific storage region of the memory 8. When the program or the data is used, the ending time data is renewed at the time of end of use. The procedure is explained hereinafter with respect to the case where a program is received by a personal communicator. In the case where image data, game data, or karaoke data is received, the same procedure is also taken.

In FIG. 14, when the power switch of the personal communicator 1 is turned on, the ending time data concerning every stored program is read out, at step S1500, from the above specific storage region of the memory 8. Next, at step S1510, the elapsed time after the ending time is calculated. It is next determined, at step S1520, whether or not the elapsed time has exceeded a predetermined time period to prevent further use of the program, and at step S1530, whether or not the elapsed time has exceeded another predetermined time period to give a warning. If the elapsed time has exceeded the predetermined time period (a first time period) to give a warning (the answer to step S1530: “YES”), a warning is given at step S1540. If the elapsed time has exceeded the predetermined time period (a second time period) to prevent further use of the program (the answer to step S1520: “YES”), the process to prevent further use of the program is performed at step S1550. If the elapsed time has not exceeded either of the above predetermined time periods, the process step shown in FIG. 14 ends.

When the process to prevent further use is performed, it is determined, at step S1560, whether or not a surcharge has been paid within a predetermined time period (a third time period). If the answer to step S1560 is negative, the process step ends. If the answer to step S1560 is affirmative, the process to allow resumption of use of the program is performed at step S1570. Next, the process to renew the ending time data with the current time concerning the program is performed at step S1580, and then the process step ends.

As in the above embodiment, instructions to pay the surcharge can be given by operating the keyboard of the communicator 1, and in response to the key operation, the host facility 100 performs the charging process.

In order to enable the choice between two modes, one of which is to calculate the elapsed time when the power switch of the personal communicator 1 is turned on as shown in FIG. 14, and the other of which is to calculate the elapsed time in the background as shown in FIG. 13, the input device 6 or the controller 25 of the personal communicator 1 may be used by the user for choosing.

While the present invention has been described herein above with respect to certain specific embodiments, in particular the distribution and control of game and karaoke data and programs, it will be appreciated by those of ordinary skill in the relevant arts that the present invention may be implemented in yet further embodiments and for yet other similar purposes. In this regard, and as described herein, the present invention is essentially directed to a method and system for controlling, from a central system or station, the time or interval during which a user system may have access to a program related element wherein a program related element may include one or more of data, programs or a combination of data and programs.

Referring to FIG. 15, therein are illustrated exemplary alternate embodiments of the present invention described herein above, but wherein the functions of a Personal Communicator 1 are implemented within a User System 100′″ such as a Personal Computer (PC) 41, which will be understood by those of ordinary skill in the arts as including a processor and memory for storing and executing programs and data and network communications elements. It will be recognized by those of ordinary skill in the arts that the functions and elements of a Personal Communicator 1 described in the exemplary embodiments of game and karaoke systems may be implemented entirely within a User System 100′″, such as a Personal Computer (PC) 41. For example, it will be recognized that many or all of the hardware elements of a Personal Communicator 1, such as Transmission Path 200 related elements and various control inputs, are typically already present and available in a conventional personal computer. It will also be recognized that the remaining elements of a Personal Communicator 1 may be implemented in a Personal Computer (PC) 41 by, for example, program implementation of the Personal Communicator 1 elements and functions. As such, User System 100′″ is represented in FIG. 15 as including a Memory 10A, Processor 100B and Input Devices 100C for storing a program related element to which access is to be controlled and for executing a program or operating on data associated with the program related element. User System 100′″ is further represented as including an Access Controller 100D, which incorporates or includes those elements of Personal Communicator 1 that are not otherwise already present in a typical User System 100′″, such as a Personal Computer 41, and that may be implemented, for example, by program control in a Personal Computer 41. Lastly, it will be further recognized that Transmission Path 200, as suggested herein above, may be implemented through the Internet, for example, thereby readily extending use of the present invention for a variety of purposes, as discussed below, to any personal computer having connection or access to the Internet or to any equivalent wide area or local area network.

It will also be apparent to those of ordinary skill in the relevant arts, however, that the implementation of the Personal Communicator 1 functions in a Personal Computer 41 may reduce the security of the overall system. As described herein, a Personal Communicator 1 is typically implemented as a dedicated hardware device, thereby corresponding limiting the possible actions that may be executed by a user in accessing data or programs. As such, a part of the security of the system and method of the present invention with regard to control of access to data or programs is achieved by the use of a separate Personal Communicator 1. The majority of functions in a personal computer, however, are implemented in or controlled through programs, and are thus significantly more vulnerable to manipulation or modification by a user. The implementation of the present invention entirely within a personal computer would thereby require modifications in the system implementing the present invention to achieve a corresponding level of security in operation.

For example, it has been described herein above with respect to certain implementations of the present system and method that a user is granted access to data or a program upon the Personal Communicator 1 detecting an action by the user to transmit a payment authorization to the Broadcasting System 100, which could be falsified by a program modification in a personal computer. In further example, it has been described herein above with respect to implementations of the present invention for game and karaoke systems that access to a game or program may be limited by deleting the data or program from the User System 100′″ when completed or after the expiration of a predetermined time or interval. The deletion of programs or data may not be desirable in certain applications, however, which will be discussed below, in that in many applications it will be preferable to preserve the data for any of a number of reasons. For example, the data may have been generated by a user of a controlled program and may belong to the user. In another example, which has been discussed herein above, it may be desirable to allow the User System 100′″ to obtain a sequence of accesses to a program or data generated by or used in association with the program, as in the continuing play of a game. In such instance, the data generated or used in association with the program should not be deleted at the conclusion of each access, but should be preserved for a subsequent access and it is typically preferable not to delete the program in order to avoid repeated downloads of the program.

It has also been described herein above that in certain implementations of the present invention, such as those allowing continuing play of a game, a program or data generated or used in association with a program is not deleted but that access to the program or data is instead “blocked” until access is re-acquired. In the implementations described previously, the “blocking” is typically achieved by blanking, masking or otherwise interfering with the display of data or by inhibiting user inputs. It will be recognized, however, that as discussed above to the falsification of payment authorizations by program modifications in a personal computer, such “blocking” methods may similarly be circumvented by program modifications in the User System 100′″.

It will be apparent to those of ordinary skill in the relevant arts that it would be preferable when implementing the present invention in a personal computer to require the reception of an access authorization by the User System 100′″ from the Broadcasting Station 100, such as an Authorization Key 1590K, before allowing access to Data 1590D or a Program 1590P. It will be recognized that this method of operation is, however, analogous to that of a game or karaoke system as described herein above. That is, in the game and karaoke systems described above a user is provided with access to Data 1590D or a Program 1590P only when an initial payment authorization has been formalized and approved and access authorization is received by the User System 100′″. In the game and karaoke systems described herein above, initial access authorization is typically provided by downloading the Data 1590D or Program 1590P while “blocking” is used to control subsequent access to Data 1590D or a Program 1590P already resident in the User System 100′″ until the user executes actions that result in a renewal of the initial access authorization. In an alternate embodiment employing Authorization Keys 1590K, the Program 1590P or Data 1590D is typically initially already resident in the User System 100′″, so the User System 100′″ is in a state similar to a game or karaoke system as described above after the initial authorization has expired and before the authorization has been renewed. The initial or a subsequent downloading of an Authorization Key 1590K then puts the User System 100′″ into a state similar to that of a game or karaoke system as described above after the initial authorization has been received or after the user has executed the actions necessary to renew an initial authorization. The primary difference, therefore, is that in this alternate implementation the authorization must be provided from a Broadcasting System 100 for each access, rather than only for an initial access and that the initial and subsequent access authorizations from the Broadcasting System 100 are required to contain only an Authorization Key 1590K, rather than the Program 1590P or Data 1590P. In this respect, it will be noted that the use of Authorization Keys 1590K allows the required authorization to be provided from the Broadcasting Station 100 for each individual access to Data 1590D or a Program 1590P because the amount or volume of information that must be downloaded for each new access authorization is significantly reduced, being a relative short key rather than an entire program or large body of data. It will therefore be recognized and understood by those of ordinary skill in the relevant arts that the use of access Authorization Keys 1590K to allow or disallow access to Data 1590D or Programs 1590P residing in the User System 100′″ upon each access request is preferable in many implementations of the present invention.

It will also be understood that an Authorization Key 1590K may be accompanied by a selectable access time or interval code, as described above with respect to exemplary embodiments of the present invention, and that an access authorization may expire at the conclusion of the selected time or interval. In other implementations, the access authorization may be permanent once the key has been received. It will be recognized, however, that the object of the present invention, that is, the control from a central system or station or the time or interval during which or at which a User System 100′″ may have access to Data 1590D, Programs 1590P or a combination of Data 1590D and Programs 1590P, will be met in embodiments employing Authorization Keys 1590K. For example, implementations wherein the Authorization Key 1590K is accompanied by a selectable access time or interval code is similar to the exemplary implementations of the present invention as embodied in game or karaoke systems and described herein above. It will also be understood that repeated access authorizations, as described herein above with respect to continuing game play, may likewise be achieved through Authorization Keys 1590K, the primary difference from the exemplary systems described herein above being that the Authorization Key 1590K is downloaded for each new access, for the reasons discussed above.

It will also be recognized that the system and method of the present invention when implemented with Authorization Keys 1590K also allows control of the time and period at which and during which a Program 1590P or body of Data 1590D is accessible in a manner similar to the exemplary game and karaoke systems described herein above. That is, in the exemplary game and karaoke systems described herein above the time and period at which and during which a Program 1590P or body of Data 1590D is accessible is controlled at the Broadcasting Station 100. For example, access to a Program 1590P or Data 1590D may be controlled at a first level by the presence or absence of the Program 1590P or body of Data 1590D in the Broadcasting Station 100 or by acceptance or rejection of requests for access, and at a second level by defining expiring periods of use that are downloaded when the Program 1590P or Data 1590D is downloaded.

In embodiments employing Authorization Keys 1590K, and as described, the Program 1590P or Data 1590D need not be resident in the Broadcasting Station 100 but may reside in a User System 100′″ or may be provided from a system separate from the Broadcasting Station 100, such as from a Broadcasting Station 100″ as described herein above. As such, it is necessary only to download an appropriate Authorization Key 1590K to grant access to the Data 1590D or Program 1590P. The first level of control may thereby be achieved by the presence or absence of an Authorization Key 1590K in the Broadcasting Station 100 or by acceptance or rejection of requests for access, and at the second level by defining expiring periods of use in the Authorization Keys 1590K and by accepting or rejecting subsequent requests for the Authorization Key 1590K.

It should be noted that the use of Authorization Keys 1590K will significantly reduce the communications and access management workload of the Broadcasting Station 100 as the Broadcasting Station 100 is required only to manage and communicate Authorization Keys 1590K, rather than the actual Programs 1590P or bodies of Data 1590D. It will also be apparent that this implementation facilitates the distribution and control of Programs 1590P or Data 1590D from a Broadcasting Station 100″ or other source, such as another User System 100′″. For example, a Program 1590P or a body of Data 1590D may be distributed directly from a Broadcasting Station 100″ to a User System 100′″, may be already resident in the User System 100′″, or may be provided to the user station in any other suitable or desired manner, a wide range of which are well known to those of ordinary skill in the relevant arts. The Broadcasting Station 100″, for example, may then control access to the Program 1590P or body of Data 1590D residing in the User System 100′″ by controlling the distribution of the Authorization Key 1590K or Authorization Keys 1590 to the Broadcasting Station 100 and by defining the conditions and requirements under which the Broadcasting Station 100 may distribute the Authorization Key 1590K or Authorization Keys 1590 to User Systems 100′″.

In this regard, each Authorization Key 1590K may be accompanied by a corresponding Access Definition 1590A containing a Period of Use Definition 1590B that may include, for example, a Start Date/Time 1590C and an End Date/Time 1590D at which access to the Program 1590P or body of Data 1590D may begin or must end and one or more Use Periods 1590E defining corresponding access periods during which access to and use of the Data 1590D or Program 1590P is permitted, such as an hour, two hours, and so on, as described previously. In this regard, and as described further below, it will be recognized that Period of Use Definition 1590B is an implementation of the access period controls described herein above with respect to the exemplary game and karaoke systems. That is, Use Periods 1590E reflect and define the use periods granted to a user for access to a Program 1590P or to Data 1590D as described in detail with respect to the game and karaoke system embodiments of the invention. It will be apparent that a Start Date/Time 1590C or an End Date/Time 1590D is a direct extension of this concept to allow control of whether access to the a given body of Data 1590D or a Program 1590P is allowed at all. It will be noted that an Access Definition 1590A may further include a Conditions 1590F, which is used to define other requirements which must be satisfied for access to the Data 1590D or Program 1590P. Such requirements may include, for example, an indication that a valid authorization for payment has been received, as described herein above with respect to the exemplary game and karaoke systems, or an identification of a user or users that are to be permitted access to the Program 1590P or Data 1590D.

A User System 100′″ may request access to the Program 1590P or body of Data 1590D by submitting a request to a Broadcasting System 100. If the requirements defined in the corresponding Access Definition 1590A are met, such as whether the request has been submitted at a date and time between the Start Date/Time 1590C and End Date/Time 1590D and whether requirements stated in Conditions 1590F, the corresponding Authorization Key 1590K will be provided from the Broadcasting Station 100 to the User System 100′″. The Authorization Key 1590K may include or be accompanied by a elements of the Access Definition 1590A, such as one or more Use Periods 1590E. The User System 100′″ may use the Authorization Key 1590K to access the Data 1590D or Program 1590P according to the accompanying requirements from the Access Definition 1590A, such as during a defined interval of use with the access authorization expiring at the end of the defined interval. Thereafter, and again depending upon the specific implementation, the User System 100′″ may continue or renew the access authorization by submitting a new access request to the Broadcasting Station 100 which, depending upon the corresponding Access Definition 1590A stored in the Broadcasting Station 100 and other requirements, such as a valid authorization for payment, the Broadcasting Station 100 will again provide an Authorization Key 1590K to the User System 100′″.

It will, therefore, be apparent that the use of Authorization Keys 1590K allows the system and method of the present invention to operate in the manner described above with respect to game and karaoke systems. That is, in a first aspect Authorization Keys 1590K allow selectable control of whether any User System 100′″ may access the Data 1590D or Program 1590P and the conditions under which the User Systems 100′″ may access the Data 1590D or Program 1590P. For example, a Start Date/Time 1590C and/or an End Date/Time 1590D in an Access Definition 1590A allow an administrative party operating on, for example, a Broadcasting System 100 or a Broadcasting System 100″, to control the distribution of and access to a body of Data 1590D or a Program 1590P by defining an interval during which the corresponding Authorization Keys 1590K may be provided to a User System 100′″. That is, the Control Unit 120 of the Broadcasting System 100 will respond to a Start Date/Time 1590C and/or End Date/Time 1590D defined in an Access Definition 1590A by allowing the distribution of the corresponding Authorization Keys 1590K only during the period defined by the Start Date/Time 1590B and/or End Date/Time 1590C. In a like manner, and in a second aspect, the Control Unit 120 will allow the Authorization Keys 1590K to be distributed only to those User Systems 100′″ meeting other requirements stated in the Conditions 1590F of the Access Definition 1590A, such as a valid authorization for payment or an identification of users who are to be permitted access to the Program 1590P or Data 1590D. Use Periods 1590E, in turn, implement the previously described control of the period or periods during which a given User System 100′″ may have access to a given body of Data 1590D and whether the access periods are renewable or continuable, as described previously with respect to the game and karaoke systems.

It will be recognized and understood by those of ordinary skill in the relevant arts that an Authorization Key 1590K may implemented in a number of forms. For example, an Authorization Key 1590K may be used to “unlock” a Program 1590P to allow execution of the Program 1590P and to thereby allow access to associated Data 1590D. In yet other embodiments the Data 1590D or Program 1590P or portions thereof may be encrypted and the Authorization Key 1590K may be a decryption key used by a Decryption Mechanism 1592D, such as a decryption program, residing in the User System 100′″ to decrypt the Data 1590D or Program 1590P, so that the receipt of the decryption Authorization Key 1590K from a Broadcasting System 100 is required for the User System 100′″ to access the Data 1590D or Program 1590P. It should be noted that in a typical embodiment using decryption Authorization Keys 1590K, the Decryption Mechanism 1592D will be either incorporated into the Program 1590P that accesses the Data 1590D or will be linked with the Program 1590P so that the decryption facility cannot be employed independently of the Program 1590P. Certain embodiments may also include an Encryption Mechanism 1592E similarly associated with the Program 1590P for encryption of Data 1590D generated by the Program 1590P wherein the encryption facility will either use an externally provided encryption key or will include a mechanism for generating or otherwise providing a decryption key appropriate for subsequently decrypting the Data 1590D.

It will also be understood that the form of Authorization Key 1590K implemented in a given instance will depend in part upon whether Data 1590D or a Program 1590P is to be controlled. For example, when the purpose of the system is to control access to a Program 1590P, it may be preferable to use Authorization Keys 1590K to “unlock” the Program 1590P rather than an decryption Authorization Key 1590K because of the greater structural complexity of a Program 1590P as opposed to the simpler structure of a data array or database. Also, “unlocking” Authorization Keys 1590K are typically more effective for protecting programs than in protecting data structures because of the “active” nature of a program as opposed to the “passive” nature of a data file. That is, a program, by its nature, is comprised of elements that must be actively executed in order to access the program and is thereby more readily “locked” by rendering one or more parts of the program unexecutable unless an appropriate key is provided. In implementations wherein the system is to control access to Data 1590D, however, and for the same reasons, the use of decryption Authorization Keys 1590K is often preferable as offering greater security and because it is often possible to decrypt only parts of a Data 1590D file at a given time, thereby further increasing the level of security.

It will also be apparent that the system and method of the present invention may be embodied for Programs 1590P and Data 1590D other than the exemplary game and karaoke entertainment systems described previously, such as for “productivity” Programs 1590P. For example, it has been described herein that the present invention may be implemented for word processing Programs 1590P, spread sheet Programs 1590P, communications Programs 1590P, such as email Programs 1590P, plug-in Programs 1590P intended for use with other Programs 1590P, and various forms of Data 1590D.

In this regard, it must be noted that the control of access to and use of productivity Programs 1590P typically requires consideration of the control of access to and use of two separately controllable types of elements comprising or associated with productivity Programs 1590P, that is, the Programs 1590P themselves and the Data 1590D generated by or for the Programs 1590P or that is used by the Programs 1590P. Such Data 1590D may include, for example, a database or file containing Data 1590D controlling the operation or functions of, for example, a word processing Program 1590P, a spreadsheet Program 1590P or an email Program 1590P, and the Data 1590D generated by the user, such as a document, spreadsheet or email message. In this regard, it must be noted that “entertainment” Programs 1590P, such as game programs, frequently are implemented in the same manner as productivity Programs 1590P. That is, a game may be comprised of a “game engine”, or Program 1590P, that is shared among several games or versions of a game and a Data 1590D file or database that defines a given game or version of a game. In addition, game Programs 1590P, like productivity Programs 1590P, also generate user Data 1590D representing, in this instance, the activities and path of the player or players through the game. For this reason, it will be recognized that the following discussions will apply equally to both entertainment systems and productivity systems.

As described herein previously, the system and method of the present invention may be used to control access to and the use of either or both of a Program 1590P and the Data 1590D generated by or for the Program 1590P, and it is apparent that the choice of the elements to be controlled and the method of control, that is, by an “unlocking” Authorization Key 1590K or by a decryption Authorization Key 1590K, will depend upon the nature of the Program 1590P and the intended application.

For example, the exemplary game and karaoke entertainment systems described herein above may be described as “rent-a-program” systems, wherein a user of a User System 100′″ pays a predetermined fee for use of a game or karaoke Program 1590P and the associated Data 1590D associated with or use by the game or karaoke Program 1590P. It will be readily appreciated that the “rent-a-program” concept may be extended to productivity Programs 1590P, such as a word processing Program 1590P, a spreadsheet Program 1590P or an Email Program 1590P.

Typical uses of this system for productivity programs would include, for example, control of the use of licensed Programs 1590P in a corporate or business environment or the providing of such program facilities to travelers in hotels or meeting centers or to users having only occasional need for such programs. It should be noted that in such applications any Data 1590D generated by a Program 1590P by a user would typically be “owned” by the user of the Program 1590P and would thus not be protected, so that the access control mechanisms would function with respect to the Programs 1590P and any Data 1590D that would be provided with the Program 1590P for use by the Program 1590P. It will also be noted that such embodiments of the present invention may be implemented with “unlocking” Authorization Keys 1590K as the element to be protected is a program rather than a body of data, but that such systems may also be implemented with decryption Authorization Keys 1590K.

Such systems could, for example, download a copy of a Program 1590P and any Data 1590D used by the Program 1590P from a Broadcasting System 100 to a User System 100′″, together with the desired period of use controls as described herein with respect to game and karaoke systems. In other implementations, the Program 1590P and associated Data 1590D could be provided to a User System 100′″ from a distributor Broadcasting System 100′ and the appropriate Authorization Key 1590K or Authorization Keys 1590K with appropriate period of use controls could be downloaded to the User System 100′″ from an administrative Broadcasting System 100. In yet other embodiments, such as for licensed use in a corporate environment, the Program 1590P and associated Data 1590D used by the Program 1590P could be resident in a User System 100′″, with the appropriate Authorization Keys 1590K provided from an administrative Broadcasting System 100 that would track and administer the use of the Program 1590P and accumulated charges.

In yet other embodiments of the present invention,the access controls will operate with respect to Data 1590D generated by a user of a Program 1590P or to Data 1590D used by the Program 1590P, rather than to the Program 1590D. As described herein above, such systems may typically be implemented with decryption Authorization Keys 1905K rather than “unlocking” Authorization Keys 1590K because the elements to be protected are Data 1590D rather than Programs 1590P.

In an exemplary implementation of such a system, the Data 1590D may comprise a database, such as an encyclopedia or dictionary or other reference source while the associated Program 1590P may in this instance be a database engine or word processing program that is to reside in the User System 100′″ for other uses, such as generalized database or word processing functions, but which is to be permitted controlled access to the database or reference source. In another example, the Data 1590D may comprise data defining a game or a version of a game while the Program 1590P may be a “game engine” used in common by several games or versions of games and that is to be freely distributed, but wherein access to the data defining a game or a version of a game is to be controlled. In each of these instances, and as described herein above,

In yet another example of embodiments of the present invention for controlling access to Data 1590D, a user operating on, for example, a Broadcasting System 100″ or on a User System 100′″ may generate a body of Data 1590D, such as a document, spreadsheet or email message, using an appropriate Program 1590P. The Data 1590D may be encrypted by an Encryption Mechanism 1592E, using an encryption key provided or generated by the Encryption Mechanism 1592E or from an external source, such as a Broadcasting System 100 or 100″. The user may then transmit the encrypted Data 1590D to another User System 100′″, either directly or through a Broadcasting System 100 or 100″. The user will also provide a corresponding decryption Authorization Key 1590K with an associated Access Definition 1590A containing the conditions and requirements for access to the Data 1590D, if necessary, to the Broadcasting System 100. Alternately, the user may request that a Broadcasting System 100″ or the Broadcasting System 100 generate and provide the corresponding Authorization Key 1590K and Access Definition 1590A.

Thereafter, any User System 100′″ that has received the encrypted Data 1590D may gain access to the unencrypted form of the Data 1590D in the manner described herein above. It will be recognized and understood that this method thereby allows, for example, control not only of which User Systems 100′″ may obtain access to the Data 1590D, but of the period or periods during which access may be obtained. The system may thereby be used, for example, to ensure that Data 1590D is not accessible after a certain selected time, thereby effectively retiring or eliminating outdated documents or messages. The system may also control the periods during which a recipient or recipients may read, review, comment upon, modify or respond to a document or message, thereby providing control of the work flow of documents and messages.

Lastly, it will be recognized that certain functions may be relocated among User Systems 100′″, Broadcasting Systems 100 and Broadcasting Systems 100″. For example, Decryption Mechanism 1592D or Encryption Mechanism 1592E or both may be located in a Broadcasting System 100 to permit, for example, centralized encryption or decryption of encrypted Data 1590D, such as in instances wherein one or more User Systems 100′″ do not include the appropriate mechanisms.

Wherefore, having described the present invention, what is claimed is:

1. A communication system for controlling use of program related element in a user system including a memory, processor and input devices for storing the program related element and for executing a program or operating on data associated with the program related element and wherein a program related element includes at least one of a program, data or a combination of a program and data, the communication system comprising:
in a user system,
an access controller for generating requests for access to the program related element and for controlling access to the program related element, and
in a host facility,
a memory for storing
an authorization key controlling access by the user system to the program related element, and
an associated access definition including
a period of use definition defining a period in which the user system may access the program related element,
the host facility being responsive to a request for access to the program related element and to the associated access definition for communicating the authorization key and at least parts of the associated access definition to the user system when requirements of the associated access definition are met, and
the access controller being responsive to the authorization key and the parts of the associated use definition for allowing the user system access to the program related element in conformance with the parts of the associated use definition.

2. The communication system of claim 1 wherein:
the program related element is resident in the user system.

3. The communication system of claim 1 wherein:
the program related element is loaded into the user system from a host system.

4. The communication system of claim 1 wherein:
the program related element is transmitted into the user system from a second user system.

5. The communication system of claim 1 wherein:
the program related element is a program,
the authorization key is an unlocking key, and
the access controller is responsive to the unlocking key for permitting access to the program related element.

6. The communication system of claim 1 wherein:
the authorization key is a decryption key,
the program related element is encrypted, and
the access controller include a decryption mechanism responsive to the decryption key to decrypt the program related element to provide the decrypted program related element to the user system.

7. The communication system of claim 6 wherein:
the program related element is generated and encrypted in a second user system,
the program related element is transmitted to the user system, and
an authorization key and associated access definition corresponding to the program related element is generated and stored in the host facility in association with the generation and encryption of the program related element.

8. The communication system of claim 1 wherein:
the access definition includes at least one of a start date/time and an end date/time defining a period in which access to the program related element is permitted.

9. The communication system of claim 1 wherein:
the access definition includes at least one user period defining at least one corresponding access period during which the user system may access the program related element and wherein the access controller is responsive to an access period for terminating access to the program related element at the expiration of the access period.

10. The communication system of claim 1 wherein:
the access definition includes conditions to be satisfied before the user system may access the program related element.

11. A method for controlling use of program related element in a user system including a memory, processor and input devices for storing the program related element and for executing a program or operating on data associated with the program related element and wherein a program related element includes at least one of a program, data or a combination of a program and data, the method comprising the steps of:
in a host facility,
storing an authorization key controlling access by the user system to the program related element and an associated access definition including a period of use definition defining a period in which the user system may access the program related element,
in the user system,
generating a request for access to the program related element,
in the host facility,
responding to a request for access to the program related element and to the associated access definition by communicating the authorization key and at least parts of the associated access definition to the user system when requirements of the associated access definition are met, and
in the user system,
responding to the authorization key and the parts of the associated use definition for allowing the user system access to the program related element in conformance with the parts of the associated use definition.

12. The method of claim 11 wherein:
the program related element is resident in the user system.

13. The method of claim 11 further comprising the step of:
loading the program related element into the user system from a host system.

14. The method of claim 11 further comprising the step of:
transmitting the program related element into the user system from a second user system.

15. The method of claim 11 wherein:
the program related element is a program,
the authorization key is an unlocking key, and
the user system is responsive to the unlocking key for permitting access to the program related element.

16. The method of claim 11 wherein:
the authorization key is a decryption key,
the program related element is encrypted, and
the user system responsive to the decryption key to decrypt the program related element to provide the decrypted program related element to the user system.

17. The communication system of claim 16, further comprising the steps of:
generating and encrypting the program related element in a second user system,
generating and storing an authorization key and associated access definition in the host facility in association with the generation and encryption of the program related element, and
transmitting the program related element to the user system.

18. The method of claim 11 wherein:
the access definition includes at least one of a start date/time and an end date/time defining a period in which access to the program related element is permitted.

19. The method of claim 11 wherein:
the access definition includes at least one user period defining at least one corresponding access period during which the user system may access the program related element and wherein the user system is responsive to an access period for terminating access to the program related element at the expiration of the access period.

20. The method of claim 11 wherein:
the access definition includes conditions to be satisfied before the user system may access the program related element.

21. A communication system for transmitting at least one of the program, the data, and a combination of the program and data from a host facility to a communication terminal device, comprising:
an input device for inputting instructions to execute the program or to process the data;
storage means for storing the program, the data, or a combination of the program and data;
executing means for executing the program stored in said storage means or executing data processing by using the data stored in said storage means, in accordance with instructions from said input device;
clock means for keeping a predetermined time period after said executing means is allowed to execute the program stored in said storage means or to execute data processing by using the data stored in said storage means; and
interference means for interfering with execution of said executing means when said clock means counts said predetermined time period.
